(19) United States
(12) Patent Application Publication
(10) Pub. No.: US 2019/0354618 A1
(43) Pub. Date: Nov. 21, 2019

(54) AUTONOMOUS DATA ISOLATION AND PERSISTENCE USING APPLICATION CONTROLLED DYNAMIC EMBEDDED DATABASE

(71) Applicant: BANK OF AMERICA CORPORATION, Charlotte, NC (US)

(72) Inventors: Harmeet Khanna Kalra, Dublin, CA (US); Paramdeep Singh Kalra, Dublin, CA (US)

(21) Appl. No.: 15/980,228

(22) Filed: May 15, 2018

(51) Int. Cl. G06F 17/30

(52) U.S. Cl. CPC G06F 17/30371; G06F 17/30339; G06F 17/30297

(57) ABSTRACT

The present invention provides for autonomous data isolation and persistence using application controlled dynamic embedded databases. Specifically, the application includes the logic to identify, through the operating system, the user and the user's home directory and, in response to such, generate user-specific embedded database at the home directory location. Since the home directory can only be accessed by the user, the embedded database and its data are shielded from other users. Further, the application provides for automatically maintaining the database, such as, modifying the database (e.g., add columns, rows, tables or the like) based on detected updates to the application and/or re-generating a new instance of the embedded database based on detected updates to the application that warrant such, detection of corrupt data in the database or the like.

### FIELD

In general, embodiments of the invention relate to computing databases, and more specifically, autonomous data isolation and persistence using application controlled dynamic embedded databases.

### BACKGROUND

In multiuser computing systems, (e.g., enterprise-wide computing networks), it is becoming more important to isolate data on a per-user basis as means of limiting security related concerns, such as malware and the spread of viruses. However, when persisting data for each individual user of the multiuser computing system, data isolation can be a challenge, especially when the data needs to be stored in a database. In specific instances, the database not only needs to segregate the individual user's data, but also the database schema may need to differ for each individual user. Additionally, a need exists for updating the schema or recreating the entire database for a particular user without impacting any other user.

Therefore, a need exists for autonomous data isolation and persistence within a database environment.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, apparatus, computer program products, and the like for autonomous data isolation and persistence using application controlled dynamic embedded databases. Specifically, the application includes the logic to identify, through the operating system, the user and the user's home directory and, in response to such, generate user-specific embedded database at the home directory location. Since the home directory can only be accessed by the user, the embedded database and its data are shielded from other users. In this regard, each user of the application has their own embedded database located at their user-specific home directory location and, thus, each user's database and associated data is isolated from the other users.

In addition, the application includes the requisite logic to control and manage the database independent of user intervention. Since the application has the logic to identify the user and their respective home directory location, the initial instance of the embedded database is dynamically generated, upon application launch, at the identified home directory location absent user input/intervention. Moreover, the application includes requisite logic to detect the need to modify the database schema based on updates to the application or the like and, in response, dynamically modify the database schema (e.g., add a new column or row to a table, add a new table, revising the size of an entry field, a column or a row within a table or the like). In addition, the application includes the requisite logic to detect the need to re-generate a table or the entire embedded database and, in response, dynamically re-generate the table or a new instance of the embedded database and delete the existing table or existing instance of the database. In this regard, the embedded database is created and maintained (e.g., modified and/or re-created) without the need for user input/intervention.

A system for generating and maintaining a user-specific embedded database defines first embodiments of the invention. The system includes a distributed computing network and a central data repository, accessible via the distributed computing network and configured to store data associated with an application for a plurality of users. The system additionally includes a data capturing application that is stored in memory and executable by at least one processor. The data capturing application is configured to, in response to launching the data capturing application, access an operating system to identify (i) the user, and (ii) a home directory location allocated to the user. The application is further configured to, in response to determining that an embedded database associated with the data capturing application does not exist at the home directory location, generate, at the home directory location, the embedded database. In response to receiving one or more user inputs that capture data for the data capturing application, the application is configured to populate the captured data in the embedded database, and subsequently transmit, via the distributed computing network, the captured data to the central data repository for data storage.

In specific embodiments of the system, the data capturing application is further configured to, in response to determining that the embedded database does exist at the home directory, determine that one or more updates to a schema of the embedded database are required, and revise the schema of the embedded database according to the one or more updates. In such embodiments of the system, the one or more updates to the schema of the database may include, but are not limited to, at least one of (i) adding a new column or row to a table in the embedded database, (ii) adding a new table to the embedded database, and (iii) revising a size of an entry field, a column or row within a table of the embedded database. Moreover, in other related embodiments of the system, determining that one or more updates to the schema of the embedded database are required may be based on an update to the application that provides for at least one of (i) an additional type of data to be captured, or (ii) a change in a form of the data to be captured.

In still further specific embodiments of the system, the data capturing application is further configured to, in response to determining that the embedded database does exist at the home directory, determine that re-generation of an existing table within the embedded database is required, re-generate, at the identified location within the home directory, a new table within the embedded database, and delete the existing table from the user-specific embedded database. In other specific embodiments of the system, the data capturing application is further configured to, in response to receiving one or more user inputs that capture data for the application and store the data in the embedded database, determine that re-generation of an existing table within the embedded database is required, transmit the captured data to the central data repository for data storage, re-generate, at the identified location within the home directory, a new table within the embedded database, and delete the existing table from the user-specific embedded database.

In other specific embodiments of the system, the data capturing application is further configured to, in response to determining that the embedded database does exist at the home directory, determine that re-generation of an existing instance of the embedded database is required, re-generate, at the identified location within the home directory, a subsequent instance of the embedded database, and delete the existing instance of the user-specific embedded database. In other related embodiments of the system the data capturing application is further configured to, the data capturing application is further configured to, in response to receiving one or more user inputs that capture data for the application and store the data in the embedded database, determine that re-generation of an existing instance of the embedded database is required, transmit the captured data to the central data repository for data storage, re-generate, at the identified location within the home directory, a subsequent instance of the embedded database, and delete the existing instance of the embedded database. In such embodiments of the system, the data capturing application may determine that the re-generation of the existing instance of the embedded database is required based on at least one of (i) an update to the application that desynchronizes the application and the existing instance of the embedded database, and (ii) corruption to the existing instance of the embedded database or data in the existing instance of the embedded database.

A computer-implemented method for generating and maintaining a user-specific embedded database defines second embodiments of the invention. The method is executed by a computing device processor and includes, in response to launching a data capturing application, accessing an operating system to identify (i) the user, and (ii) a home directory location allocated to the user. Further, the method includes, in response to determining that an embedded database does not exist at the home directory location, generating, at the home directory location, the embedded database associated with the data capturing application. Further, the method includes, in response to receiving one or more user inputs that capture data for the application, storing the captured data in the embedded database, and transmitting, via a distributed computing network, the captured data to a central data repository for data storage.

In specific embodiments the computer-implemented method further includes, in response to determining that the embedded database does exist at the home directory, determining that one or more updates to a schema of the embedded database are required, and revising the schema of the embedded database according to the one or more updates. In such embodiments of the method, the one or more updates to the schema of the database may include at least one of (i) adding a new column or row to a table, (ii) adding a new table, and (iii) revising a size of an entry field, a column or row within a table. Further, determining that one or more updates to the schema of the embedded database are required may be based on an update to the application that provides for at least one of (i) an additional type of data to be captured, or (ii) a change in a form of the data to be captured.

In still further specific embodiments of the computer-implemented method includes, in response to determining that the embedded database does exist at the home directory, determining that re-generation of an existing table within the embedded database or re-generation of an existing instance of the embedded database is required, re-generating, at the identified location within the home directory, a new table within the embedded database or a subsequent instance of the embedded database, and deleting the existing table from the user-specific embedded database or the existing instance of the embedded database. In such embodiments of the computer-implemented method, determining that the re-generation of the existing table or the existing instance of the embedded database may be based on at least one of (i) an update to the application that desynchronizes the application and the existing table or the existing instance embedded database, and (ii) database corruption.

A computer program product including a non-transitory computer-readable medium defines third embodiments of the invention. The computer-readable medium includes a first set of codes for causing a computer to, in response to launching a data capturing application, access an operating system to identify (i) the user, and (ii) a home directory location allocated to the user. The computer-readable medium additionally includes a second set of codes for causing a computer to, in response to determining that an embedded database does not exist at the home directory location, generate, at the home directory location, the embedded database associated with the data capturing application. In addition, the computer-readable medium includes a third set of codes for causing a computer to, in response to receiving one or more user inputs that capture data for the application, storing the captured data in the embedded database, and a fourth set of codes for causing a computer to transmit, via a distributed computing network, the captured data to a central data repository for data storage.

In specific embodiments of the computer program product, the computer-readable medium includes a fifth set of codes for causing a computer to, in response to determining that the embedded database does exist at the home directory, determine that one or more updates to a schema of the embedded database are required, and a sixth set of codes for causing a computer to revise the schema of the embedded database according to the one or more updates. In such embodiments of the computer program product the one or more updates to the schema of the database may include at least one of (i) adding a new column or row to a table, (ii) adding a new table, and (iii) revising a size of an entry field, a column or row within a table. In further specific embodiments the fifth set of codes is further configured to cause the computer to determine that one or more updates to the schema of the embedded database are required based on an update to the application that provides for at least one of (i) an additional type of data to be captured, or (ii) a change in a form of the data to be captured.

In still further embodiments of the computer program product, the computer-readable medium further includes a fifth set of codes for causing a computer to, in response to determining that the embedded database does exist at the home directory, determine that re-generation of an existing table within the embedded database or re-generation of an existing instance of the embedded database is required. In addition, the computer-readable medium includes a sixth set of codes for causing a computer to re-generate, at the identified location within the home directory, a new table within the embedded database or a subsequent instance of the embedded database, and a seventh set of codes for causing a computer to delete the existing table from the user-specific embedded database or the existing instance of the embedded database.

Thus, systems, apparatus, methods, and computer program products herein described in detail below provide for The present invention provides for autonomous data isolation and persistence using application controlled dynamic embedded databases. Specifically, the application includes the logic to identify, through the operating system, the user and the user's home directory and, in response to such, generate user-specific embedded database at the home directory location. Since the home directory can only be accessed by the user, the embedded database and its data are shielded from other users. Further, the application provides for automatically maintaining the database, such as, modifying the database (e.g., add columns, rows, tables or the like) based on detected updates to the application and/or re-generating a new instance of the embedded database based on detected updates to the application that warrant such, detection of corrupt data in the database or the like.

Thus, systems, apparatus, methods, and computer program products herein described in detail below provide for autonomous data isolation and persistence using application controlled dynamic embedded databases. Specifically, the application includes the logic to identify, through the operating system, the user and the user's home directory and, in response to such, generate user-specific embedded database at the home directory location. Since the home directory can only be accessed by the user, the embedded database and its data are shielded from other users. Further, the application provides for automatically maintaining the database, such as, modifying the database (e.g., add columns, rows, tables or the like) based on detected updates to the application and/or re-generating a new instance of the embedded database based on detected updates to the application that warrant such, detection of corrupt data in the database or the like.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a schematic diagram of an exemplary system for generating user-specific embedded databases within a data-capturing application, in accordance with embodiments of the present invention;

FIG. 2 provides a block diagram on a computing platform configured to generate and maintain user-specific embedded databases within a data-capturing application, in accordance with embodiments of the present invention;

FIG. 3 provides a flow diagram of a method for generating and maintaining a user-specific embedded database within a data-capturing application, in accordance with embodiments of the present invention; and

FIG. 4 provides a flow diagram of a method for generating and maintaining a user-specific embedded database within a data-capturing application, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for autonomous data isolation and persistence using application-controlled dynamic embedded databases. Specifically, a data-capturing application includes logic to identify, through the operating system, the user and the user's home directory and, in response to such, generate a user-specific embedded database at the home directory location. Since the home directory can only be accessed by the user, the embedded database and its data are shielded from other users. In this regard, each user of the application has their own embedded database located at their user-specific home directory location and, thus, each user's database and associated data is isolated from the other users.

In addition, the application includes the requisite logic to maintain the database independent of user intervention. Since the application has the logic to identify the user and their respective home directory location, the initial instance of the embedded database is dynamically generated, upon application launch, at the identified home directory location absent user input/intervention. Moreover, the application includes requisite logic to detect the need modify the database schema based on updates to the application or the like and, in response, dynamically modify the database schema (e.g., add a new column or row to a table, add a new table, revising the size of an entry field, a column or a row within a table or the like). In addition, the application includes the requisite logic to detect the need to re-generate a table or the entire embedded database and, in response, dynamically re-generate the table or a new instance of the embedded database at the home directory and delete the existing table or existing instance of the database from the home directory. In this regard, the embedded database is created and maintained (e.g., modified and/or re-created) without the need for user input/intervention.

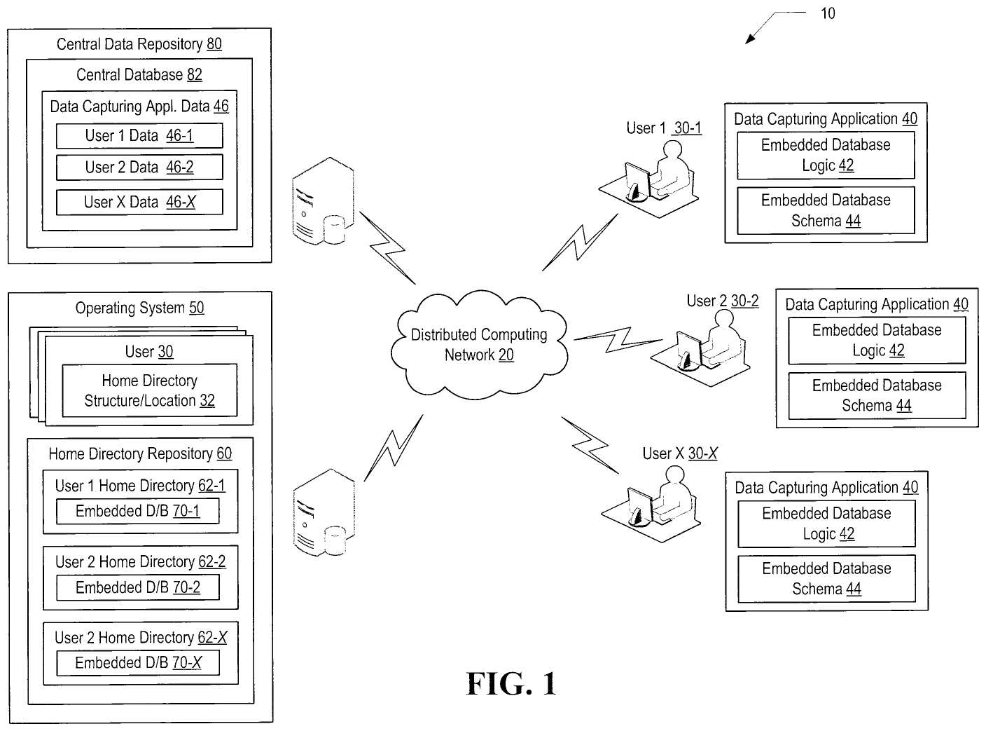

Referring to FIG. 1, a schematic diagram is provided of an exemplary system 10 for generating user-specific embedded databases at home directory locations, in accordance with embodiments of the present invention. The system 10 is implemented via a distributed computing network 20, such as intranet or the like. Individual users 30-1, 302 and 30-X are provided access to a data-capturing application 40 through a workstation (e.g., PC, laptop or the like). The data-capturing application includes embedded database logic 42 that is configured to generate and maintain an embedded database.

Specifically, upon launch, the data-capturing application is configured to access the operating system 50, to identify the user 30 and the home directory location 32 associated with the user 30. In specific embodiments of the invention, prior to data-capturing application launch the user will have logged-on to the distributed computing network 20 and, thus, the operating system 50 has knowledge as to the identity of the user 30. In response to identifying the user 30 and the user's home directory location 32, the embedded database logic 42 uses the embedded data base schema 44 in the application 40 to generate an embedded database 40 within the user's home directory location 62 of the home directory repository 60. In this regard, each individual user 30-1, 30-2, 30-X of the data-capturing application 40 will have their own respective embedded database 70-1, 70-2, 70-X persisted within their respective home directory location 62-1, 62-2, 62-X. Since the home directory 62-1, 62-2, 62-X can only be accessed by the associated user 30-1, 302, 30X, the embedded database 70-1, 70-2, 70-X and its data are isolated from other users. Data that is captured by the application 40 and persisted in respective embedded databases 70-1, 70-2 and 70-X is subsequently transmitted, via distributed computing network 20, from the embedded databases 70-1, 70-2, 70-X to a central data repository 80. The central repository 80 houses central database 82 that stores data-capturing application data 46, such as user 1 data 46-1, user 2 data 46-2, user X data 46-X and the like.

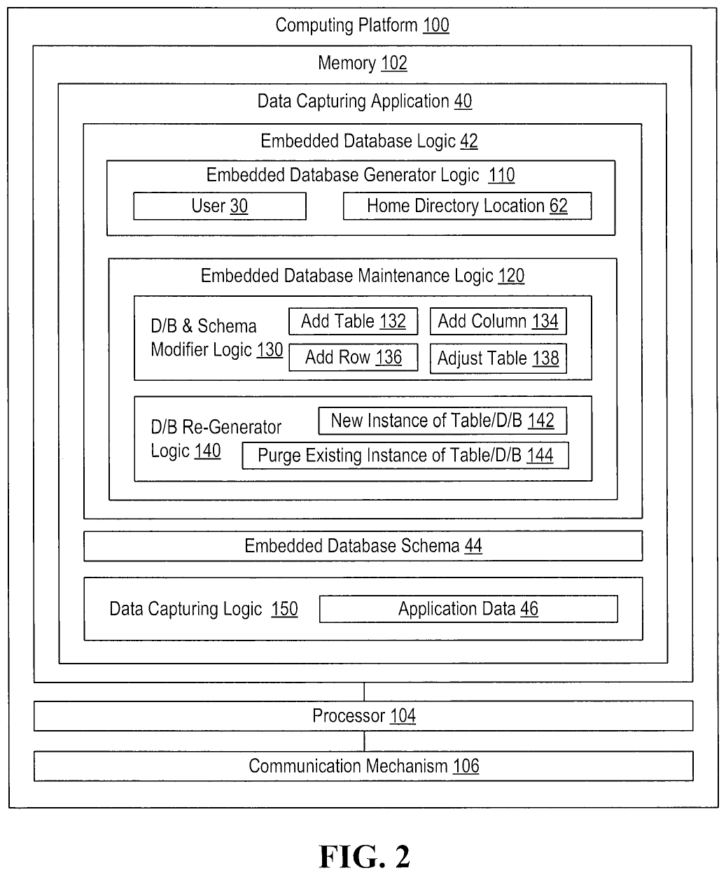

Referring to FIG. 2 a block diagram is presented of a computing platform 100 configured to execute the data-capturing application 40, which generates and maintains the user-specific embedded database 70, in accordance with embodiments of the present invention. In addition to providing more details for the system 10, FIG. 2 provides various optional embodiments of the system 10. The computing platform 100 may comprise one or more computing devices, such as personal computers, laptops and the any other computing device that is capable of executing data-capturing application 40. The computing platform 100 includes a memory 102, and a processor 104 in communication with the memory. The memory 104 may comprise volatile and non-volatile memory, such as read-only and/or random-access memory (RAM and ROM), EPROM, EEPROM, flash cards, or any memory common to computer platforms).

The processor 106 may be application-specific integrated circuits (“ASICs”), or other chipsets, logic circuits, or other data processing device(s). Processor 106 may execute an application programming interface (“API”) (not shown in FIG. 2) that interfaces with any resident programs (i.e., data-capturing application 40) stored in the memory 102 of the computing platform 100. Processor 104 may include various processing subsystems (not shown in FIG. 2) embodied in hardware, firmware, software, and combinations thereof, that enable the functionality of the computing platform 100 and the operability of the computing platform 100 on a distributed computing network (20 shown in FIG. 1) that allows for the computing platform 100 to communicate with the operating system 50 (shown in FIG. 1) and central data repository 89 (shown in FIG. 1). For example, processing subsystems allow for initiating and maintaining communications and exchanging data with other networked devices. For the disclosed aspects, processing subsystems of processor 104 may include any subsystem used in conjunction with data-capturing application 40 and related, codes, routines, sub-routines, algorithms, sub-algorithms, modules, sub-modules thereof.

The computing platform 100 additionally includes communication mechanism 106 embodied in hardware, firmware, software, and combinations thereof, that enables electronic communications between the computing platform 100 and other platforms, apparatus and/or devices, such as operating system 50 and central data repository 80. Thus, communication mechanism 106 may include the requisite hardware, firmware, software and/or combinations thereof for establishing and maintaining a network communication connection.

The memory 102 of computing platform 104 stores data-capturing application 40, which includes embedded database logic 42 that is executable by processor 104 and configured to generate and maintain, absent user intervention, a user-specific embedded database 70 (shown in FIG. 1), in accordance with embodiments of the present invention. The embedded database logic 42 includes embedded database generator logic 110 that is configured to generate, absent user input/intervention, a user-specific embedded database 70 within the user's home directory location 62 (shown in FIG. 1). Upon data-capturing application 40 launch, the embedded database generator logic 110 is configured to access the operating system 50 (shown in FIG. 1) to identify the user and the user's home directory location 62. The embedded database generator logic 110 is configured to determine if an embedded database exists at the home directory location 110, and in the event that the determination results in no embedded database currently existing at the home directory location 110, the embedded database generator logic 110 is configured to generate the embedded database 70 at the user's home directory location 62. The embedded database generator logic 110 will access the embedded database schema 44 to determine how the database is to be constructed and will populate the database with information used by the data-capturing application 40 (e.g., options presented in drop-down menu(s) or other user options) from one or more internal files (e.g., spreadsheet type files or the like).

The embedded database logic 42 additionally includes embedded database maintenance logic 120, which is configured to provide requisite maintenance to the embedded database, absent user input/intervention. Specifically, embedded database maintenance logic 120 includes database and schema modifier logic 130 that is configured to modify the embedded database 70 and/or schema 44 based on revisions/updates to the data-capturing application 40 that require such modification to the embedded database schema. For example, the data-capturing application 40 may be updated/revised so as to require a new type of data to be captured or a change in form of a data being captured. Such changes to the data-capturing application 40 may result in the need to add a new table 132 to the embedded database 70, add a new column(s) 134 to one or more tables in the embedded database 70, add a new row(s) 136 to one or more tables in the embedded database 70 or otherwise adjust the configuration of a table 138, including, but not limited to, adjustment of a data entry field, a row or column. As such, the schema modifier logic 130 is configured to automatically (i.e., without user intervention) detect the need to modify the embedded database schema 44 and/or the embedded database 70 based on a revision/update to the data-capturing application 40 and, in response, automatically modify the embedded database schema 44 and/or the embedded database 70 in accordance with the modifications/changes required. In the event that the data-capturing application 40 has yet to generate an embedded database 70 for a user 30 or no instance of an embedded database 70 currently exists at the home directory location 62, the modification(s) may be limited to the embedded database schema 44 stored in the data-capturing application 40. While in other instances, in which the embedded database 70 does exist at the home directory location 62, the modification(s) may be made to the embedded database schema 44 and the embedded database 70 at the home directory location 62.

The embedded database logic 42 additionally includes embedded database re-generator logic 140, which is configured to re-generate a table or a new instance of the embedded database 142 in response to revisions/updates to the data-capturing application 40 that require re-generation of the table(s) or the entire database 70 (i.e., the database or the table(s) are out of synchronization with the application) or a determination that the database 70 or data within the database 70. In this regard, the embedded database re-generator logic 140 is configured to detect the need to re-generate a table or a new instance of the embedded database 142 and, in response to such detection, re-generate a table(s) or the new instance of the database 142. Further, the embedded database re-generator logic 140 is configured to purge/delete the existing table(s) from the embedded database or the existing instance of the embedded database 144 in the home directory. In the event that the need to regenerate a table or new instance of the database 142 is detected while a user 30 is using the data-capturing application 40 (e.g., data or the database is determined to be corrupt while data is being captured), the embedded database re-generator logic 140 is configured to transmit the application data 46 captured by the data—capturing logic 150 and persisted in the existing table or the existing instance of the embedded database 70, prior to purging/deleting the existing instance of the table or the embedded database 70 from the home directory location 62.

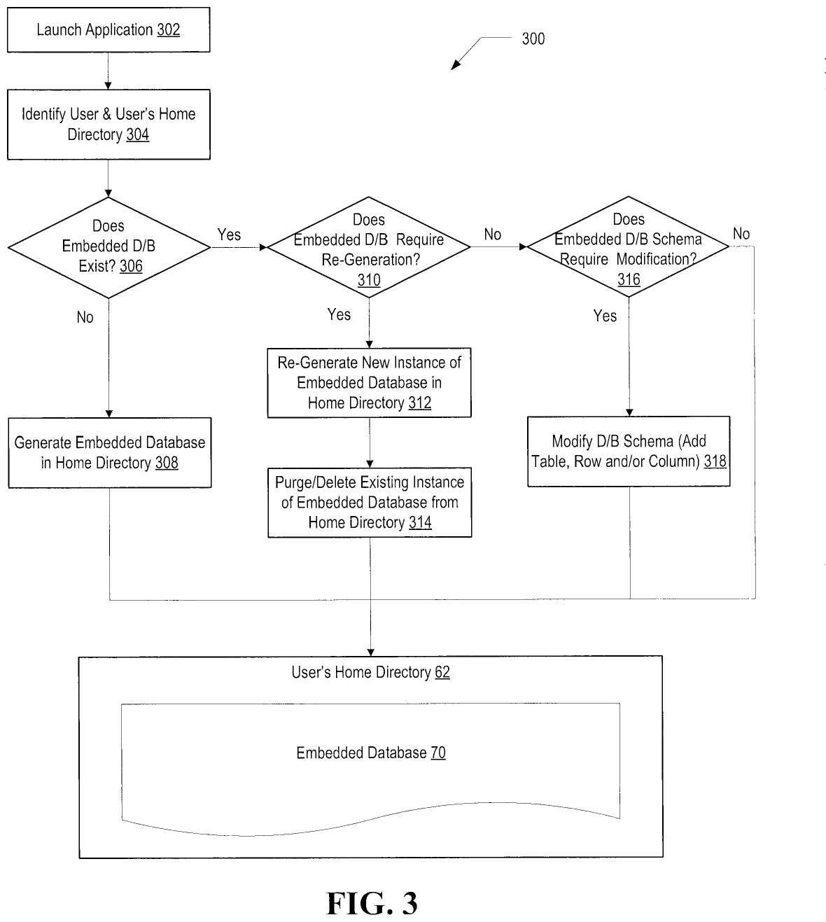

Referring to FIG. 3 a flow diagram is show of a method 300 for generating and maintaining a user-specific embedded database within a data-capturing application, in accordance with embodiments of the invention. At Event 302, a user launches the data-capturing application, and in response, at Event 304, the user of the application and the user's home directory location are identified. In this regard, the user, prior to launching the application, will have previously logged into the computing network (e.g., intranet or the like) and provided requisite user credentials (e.g., user ID and passcode) and, as a result, the application is configured to access the operating system to identify the user and the user's home directory location without the user providing any input to the application.

In response to identifying the user and the user's home directory location, at Decision 306, the application determines if the embedded database associated with the application exists at the home directory location. If a determination is made that the embedded database does not exist at the home directory location (e.g., first time use of the application or the embedded database has timed-out due to non-use), at Event 308, the application generates the embedded database in the user's home directory location, absent user intervention/input, using a schema stored in the application and populating the database with configuration data stored in one or more application files. Once the embedded database has been created, user inputs to the data capturing application populate entry fields in the embedded database 70 stored in the user's home directory 62 and the data persisted in the embedded database is subsequently transmitted to a central data repository.

If a determination is made that the embedded database associated with the application does exist at the home directory location, at Decision 310, a determination is made as to whether the embedded database or tables within the database require re-generation. Re-generation of table(s) or the entire embedded database may be required based on the database being out-of-synchronization with the application (e.g., updates/revisions to the application have occurred) and/or the database or data within the database has been determined to be corrupt. If a determination is made that the embedded database or tables within the database require re-generation, at Event 312, a new instance of the embedded database is re-generated in the home directory or new tables are re-generated for insertion into the embedded database and, at Event 314, the existing instance of the embedded database or the existing tables being re-generated are purged from the home directory or database. The re-generation of the new instance of the embedded database and the purging of the existing instance of the new database occur absent user intervention/input and may occur absent user knowledge. In the event that the need to re-generate the embedded database or tables within the database occurs after application launch and after data has persisted in the database (i.e., the user has provided inputs to the application), the data existing in the tables or database will be transmitted to a central data repository prior to purging/deleting the existing instance of the embedded database or the existing tables within the database. Once the new instance of the embedded database is in the home directory, the user inputs to the data capturing application populate entry fields in the new instance of the embedded database 70 stored in the user's home directory 62 and the data persisted in the new instance of the embedded database is subsequently transmitted to a central data repository.

If a determination is made that the embedded database does not require re-generation, at Decision 316, a determination is made as to whether the embedded database or requires modification. Modification of the embedded database (e.g., adding tables, columns, rows or making other adjustments to the schema) may be required based on the database being out-of-synchronization with the application (e.g., updates/revisions to the application have occurred which require modifying the database but do not require re-generation of the database). If a determination is made that the embedded database requires modification, at Event 318, the embedded database is modified (e.g., new tables, columns, rows are added the embedded database) other adjustments to the database schema are performed). The modifications to the embedded database occur absent user intervention/input and may occur absent user knowledge. Once the modifications to the embedded database have been performed, the user inputs to the data capturing application populate entry fields in the embedded database 70 stored in the user's home directory 62 and the data persisted in the embedded database is subsequently transmitted to a central data repository.

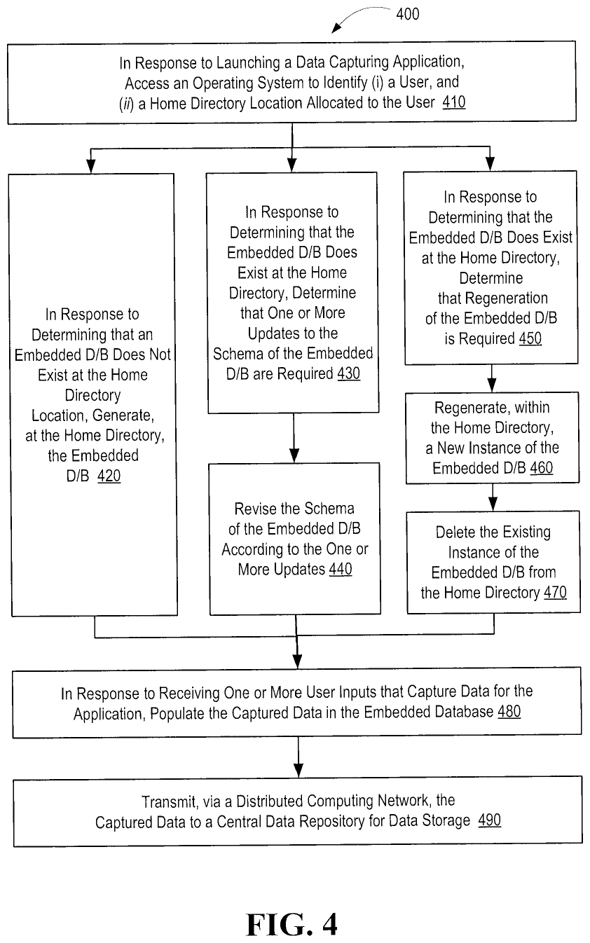

Referring to FIG. 4 an additional flow diagram is presented of a method 400 for generating and maintaining an embedded database within a data-capturing application, in accordance with additional embodiments of the invention. At Event 400, in response to a user launching a data-capturing application, an operating system is accessed to identify the user and the home directory location allocated to the user. Prior to launching the application, the user will have logged into the computing network (e.g., intranet or the like) and provided requisite user credentials (e.g., user ID and passcode) and, as a result, the application is configured to access the operating system to identify the user and the user's home directory location without the user providing any input to the application.

At Event 420, in response to the application determining that an embedded database does not exist at the home directory location, an embedded database is generated at the home directory location, absent user intervention/input, using a schema stored in the application and populating the database with configuration data stored in one or more application files.

At Event 430, in response to the application determining that the embedded database exists at the home directory location, a determination is made that modifications/updates to the embedded database are required and, as a result, at Event 440, the embedded database is updated/modified accordingly. The modifications/updated to the embedded database may include, but are not limited to, adding tables, columns, rows to the embedded database or making other adjustments to the embedded database schema. The modifications/updates to the embedded database may be based on the database being out-of-synchronization with the data-capturing application (e.g., updates to the data-capturing application that require a new type of data to be captured, a new data entry format or the like). In accordance with the invention, the modifications to the embedded database occur absent user intervention.

At Event 450, in response to application determining that the embedded exists at the home directory location, a determination is made that a re-generation of the tables within the database or the entire embedded database is required. In response to such a determination, at Event 460, a new instance of the embedded database is re-generated in the home directory or new tables are re-generated for insertion into the embedded database and, at Event 470, the existing instance of the embedded database or the existing tables being re-generated are purged from the home directory or database. Re-generation of table(s) or the entire embedded database may be required based on the database being out-of-synchronization with the application (e.g., updates/revisions to the application have occurred) and/or the database or data within the database has been determined to be corrupt. In accordance with the invention, the re-generation of the embedded database occurs absent user intervention.

At Event 480, in response to receiving user inputs that capture data for the data-capturing application, the captured data is populated into the embedded database and, at Event 490, the data in the embedded database is transmitted, via distributed computing network, to a central data repository. Once transmitted, the captured data in the embedded database may persist for a predetermined period of time before the data is purged from the embedded database.

Thus, systems, apparatus, methods, and computer program products described above provide for autonomous data isolation and persistence using application controlled dynamic embedded databases. Specifically, the application includes the logic to identify, through the operating system, the user and the user's home directory and, in response to such, generate user-specific embedded database at the home directory location. Since the home directory can only be accessed by the user, the embedded database and its data are shielded from other users. Further, the application provides for automatically maintaining the database, such as, modifying the database (e.g., add columns, rows, tables or the like) based on detected updates to the application and/or re-generating a new instance of the embedded database based on detected updates to the application that warrant such, detection of corrupt data in the database or the like.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for generating and maintaining an embedded database within an application that is specific to the user of the application, the system comprising:
a distributed computing network;
a central data repository, accessible via the distributed computing network and configured to store data associated with a data capturing application for a plurality of users; and
the data capturing application stored in memory, executable by at least one processor and configured to:
in response to launching the data capturing application, access an operating system to identify (i) the user, and (ii) a home directory location allocated to the user; and
in response to determining that an embedded database does not exist at the home directory location, generate, at the home directory location, the embedded database,
in response to receiving one or more user inputs that capture data for the data capturing application, store the captured data in the embedded database, and
transmit, via the distributed computing network, the captured data to the central data repository for data storage.

2. The system of claim 1, wherein the data capturing application is further configured to:
in response to determining that the embedded database does exist at the home directory, determine that one or more updates to a schema of the embedded database are required, and
revise the schema of the embedded database according to the one or more updates.

3. The system of claim 2, wherein the one or more updates to the schema of the database includes at least one of (i) adding a new column or row to a table, (ii) adding a new table, and (iii) revising a size of an entry field, a column or row within a table.

4. The system of claim 2, wherein the data capturing application is further configured to determine that one or more updates to the schema of the embedded database are required based on an update to the data capturing application that provides for at least one of (i) an additional type of data to be captured, or (ii) a change in a form of the data to be captured.

5. The system of claim 1, wherein the data capturing application is further configured to:
in response to determining that the embedded database does exist at the home directory, determine that re-generation of an existing table within the embedded database is required,
re-generate, at the identified location within the home directory, a new table within the embedded database, and
delete the existing table from the user-specific embedded database.

6. The system of claim 1, wherein the data capturing application is further configured to:
in response to receiving one or more user inputs that capture data for the data capturing application and store the data in the embedded database, determine that re-generation of an existing table within the embedded database is required,
transmit the captured data to the central data repository for data storage,
re-generate, at the identified location within the home directory, a new table within the embedded database, and
delete the existing table from the user-specific embedded database.

7. The system of claim 1, wherein the data capturing application is further configured to:
in response to determining that the embedded database does exist at the home directory, determine that re-generation of an existing instance of the embedded database is required,
re-generate, at the identified location within the home directory, a subsequent instance of the embedded database, and
delete the existing instance of the user-specific embedded database.

8. The system of claim 7, wherein the data capturing application is further configured to determine that the re-generation of the existing instance of the embedded database is required based on at least one of (i) an update to the data capturing application that desynchronizes the data capturing application and the existing instance of the embedded database, and (ii) corruption to the existing instance of the embedded database or data in the existing instance of the embedded database.

9. The system of claim 1, wherein the data capturing application is further configured to:
in response to receiving one or more user inputs that capture data for the data capturing application and store the data in the embedded database, determine that re-generation of an existing instance of the embedded database is required,
transmit the captured data to the central data repository for data storage,
re-generate, at the identified location within the home directory, a subsequent instance of the embedded database, and
delete the existing instance of the embedded database.

10. The system of claim 9, wherein the data capturing application is further configured to determine that the re-generation of the embedded database is required based on database corruption.

11. A computer-implemented method for generating and maintaining a user-specific embedded database, the method executed by a computing device processor and comprising:
in response to launching a data capturing application, accessing an operating system to identify (i) the user, and (ii) a home directory location allocated to the user; and
in response to determining that an embedded database does not exist at the home directory location, generating, at the home directory location, the embedded database associated with the data capturing application,
in response to receiving one or more user inputs that capture data for the data capturing application, storing the captured data in the embedded database, and
transmitting, via a distributed computing network, the captured data to a central data repository for data storage.

12. The computer-implemented method of claim 11, further comprising:
in response to determining that the embedded database does exist at the home directory, determining that one or more updates to a schema of the embedded database are required, and
revising the schema of the embedded database according to the one or more updates, wherein the one or more updates to the schema of the database includes at least one of (i) adding a new column or row to a table, (ii) adding a new table, and (iii) revising a size of an entry field, a column or row within a table.

13. The computer-implemented method of claim 12, wherein determining that one or more updates to the schema of the embedded database are required further comprises determining that one or more updates to the schema of the embedded database are required based on an update to the data capturing application that provides for at least one of (i) an additional type of data to be captured, or (ii) a change in a form of the data to be captured.

14. The computer-implemented method of claim 12, further comprising:
in response to determining that the embedded database does exist at the home directory, determining that re-generation of an existing table within the embedded database or re-generation of an existing instance of the embedded database is required,
re-generating, at the identified location within the home directory, a new table within the embedded database or a subsequent instance of the embedded database, and
deleting the existing table from the user-specific embedded database or the existing instance of the embedded database.

16. The computer-implemented method of claim 14, wherein determining that the re-generation of the existing table or the existing instance of the embedded database is required further comprises determining that the re-generation of the existing table or the existing instance of the embedded database is required based on at least one of (i) an update to the data capturing application that desynchronizes the data capturing application and the existing table or the existing instance embedded database, and (ii) database corruption.

17. A computer program product including a non-transitory computer-readable medium, the computer-readable medium comprising:
a first set of codes for causing a computer to, in response to launching a data capturing application, access an operating system to identify (i) the user, and (ii) a home directory location allocated to the user; and
a second set of codes for causing a computer to, in response to determining that an embedded database does not exist at the home directory location, generate, at the home directory location, the embedded database associated with the data capturing application,
a third set of codes for causing a computer to, in response to receiving one or more user inputs that capture data for the data capturing application, storing the captured data in the embedded database, and
a fourth set of codes for causing a computer to transmit, via a distributed computing network, the captured data to a central data repository for data storage.

18. The computer program product of claim 11, wherein the computer-readable medium further comprises:
a fifth set of codes for causing a computer to, in response to determining that the embedded database does exist at the home directory, determine that one or more updates to a schema of the embedded database are required, and
a sixth set of codes for causing a computer to revise the schema of the embedded database according to the one or more updates, wherein the one or more updates to the schema of the database includes at least one of (i) adding a new column or row to a table, (ii) adding a new table, and (iii) revising a size of an entry field, a column or row within a table.

19. The computer program product of claim 18, wherein the fifth set of codes is further configured to cause the computer to determine that one or more updates to the schema of the embedded database are required based on an update to the data capturing application that provides for at least one of (i) an additional type of data to be captured, or (ii) a change in a form of the data to be captured.

20. The computer program product of claim 17, wherein the computer-readable medium further comprises:
a fifth set of codes for causing a computer to, in response to determining that the embedded database does exist at the home directory, determine that re-generation of an existing table within the embedded database or re-generation of an existing instance of the embedded database is required,
a sixth set of codes for causing a computer to re-generate, at the identified location within the home directory, a new table within the embedded database or a subsequent instance of the embedded database, and
a seventh set of codes for causing a computer to delete the existing table from the user-specific embedded database or the existing instance of the embedded database.
